(19) United States
(12) Patent Application Publication
(10) Pub. No.: US 2003/0184670 A1
(43) Pub. Date: Oct. 2, 2003

(54) Recording or reproducing apparatus using a disc medium

(75) Inventors: Yasuhiro Hashiguchi, Mito (JP); Kazuyuki Kodama, Mito (JP); Takao Naitou, Mito (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/301,331

(22) Filed: Nov. 20, 2002

(30) Foreign Application Priority Data
Mar. 28, 2002 (JP) 2002-090183

(51) Int. Cl. H04N 5/232

(52) U.S. Cl. 348/345

(57) ABSTRACT

In a disc apparatus, such as an optical disc video camera, etc., for recording or reproducing information onto/from a disc medium received in a cartridge, for obtaining reduction in a number of parts building up a mechanism for holding a clamper, thereby achieving a cartridge holder mechanism of a thinner type, wherein a clamper for holding the disc medium while pressing thereon is engaged with a clamp holder (a reinforcing plate) which opens/closes with a disc cover (an outer cover) of an exterior of the apparatus in the structure thereof. With this, With this, the disc slider becomes unnecessary, which was disposed for moving the clamper being held therewith.

Also, although a relative positional shift occurs between the clamper and the cartridge holder during rotation of the cartridge holder since the rotation shaft of the clamper differs from the rotation shaft of the cartridge holder, however a guide portion is formed on the cartridge holder as a unit, thereby in the structure thereof, regulating it with this, when the clamper comes close to the cartridge holder.

### BACKGROUND OF THE INVENTION

1. Filed of the Invention

The present invention relates to a disc apparatus being able to record or reproduce data onto/from a disc medium inserted or received in a cartridge, and in particular relates to the structure in relation to insertion, ejection or holding of the cartridge into/from/in the disc apparatus.

2. Description of the Related Art

An example of a loading mechanism of a video camera, which uses an optical disc cartridge, in relation to the conventional art, is disclosed in Japanese Patent Laying-Open No. 2000-21059 (JP-A 21059/2000), for example. In the conventional technology disclosed, it is proposed to achieve an object to insert a disc clamper into the cartridge with certainty and accuracy, with the mechanism for holding a disc-like recording medium between a disc table and a disc clamper. The disc clamper must be disposed escaping from a moving path of the cartridge, until when the cartridge is loaded or mounted. Then, according to this publication, a disc slider 260 is provided on a disc tray 250, so as to attach the disc clamper 300 to this disc slider, thereby achieving the object mentioned above, i.e., escaping from the moving path of the cartridge. When the cartridge is loaded, the disc clamper is guided by means of a guiding slit formed in the disc tray 256a, thereby holding the cartridge therebetween, in the structure thereof.

### BRIEF SUMMARY OF THE INVENTION

As was mentioned in the above, in relation with the conventional art, for the purpose of holding the cartridge by means of the disc clamper (hereinafter, being called only by “clamper”), the disc slider is provided in an upper side, being a member separated from the disc tray. For letting this disc slider to rotate coaxially with the disc tray, parts or elements thereof must be large in the number thereof, and since the disc slider is located in an upper side of the disc tray, a whole of cartridge holder device comes to be thick in the thickness thereof.

Accordingly, an object of the present invention is to provide a cartridge holder device of a type of thinner in the thickness, in the disc apparatus, such as a optical disc video camera, etc., while reducing the number of parts of the mechanism for holding the clamper.

For achieving such the object as was mentioned above, according to the present invention, there is provided a disc apparatus, for recording or reproducing information onto/from a disc medium, by loading a cartridge, in which said disc medium is stored, in the structure threof, wherein a clamper for holding the disc medium while pressing is engaged with a clamp holder (a reinforcing plate) which opens/closed with a disc cover (an outer cover) of the exterior of the apparatus as a unit. With this, the disc slider becomes unnecessary, which was disposed for moving the clamper being held therewith.

Also, although a relative positional shift occurs between the clamper and the cartridge holder during rotation of the cartridge holder since the rotation shaft of the clamper differs from the rotation shaft of the cartridge holder, however a guide portion is formed on the cartridge holder as a unit, thereby in the structure thereof, regulating it with this, when the clamper comes close to the cartridge holder.

### BRIEF DESCRIPTION OF THE DRAWINGS

Those and other objects, features and advantages of the present invention will become more readily apparent from the following detailed description when taken in conjunction with the accompanying drawings wherein:

FIG. 1 is an exploded view of principle portions of an optical disc video camera, according to an embodiment of the present invention;

FIG. 2 is a perspective view of the video camera seen behind thereof, under the condition where a disc cover 5 is opened;

FIG. 3 a plane view of a cartridge 15 for user of the video camera, for explanation thereof;

FIG. 4 is a perspective view for showing the structure of a mechanical portion 14 from a right-upper side, obliquely;

FIG. 5 is a perspective view for showing the condition where the cartridge is locked on a cartridge holder after completing insertion of the cartridge;

FIG. 6 is a side view of FIG. 5;

FIG. 7 is a side view of the cartridge under the condition of being recordable or reproducible; and

FIG. 8 is a cross-section view elements of a clamper portion.

### DETAILED DESCRIPTION OF THE INVENTION

Hereinafter, embodiments according to the present invention will be fully explained by referring to the attached drawings, in particular on an optical disc video camera, for an example, for recording video and/or audio taken into onto a recoding medium, an optical disc, such as an optical disc stored or received in a cartridge, for example.

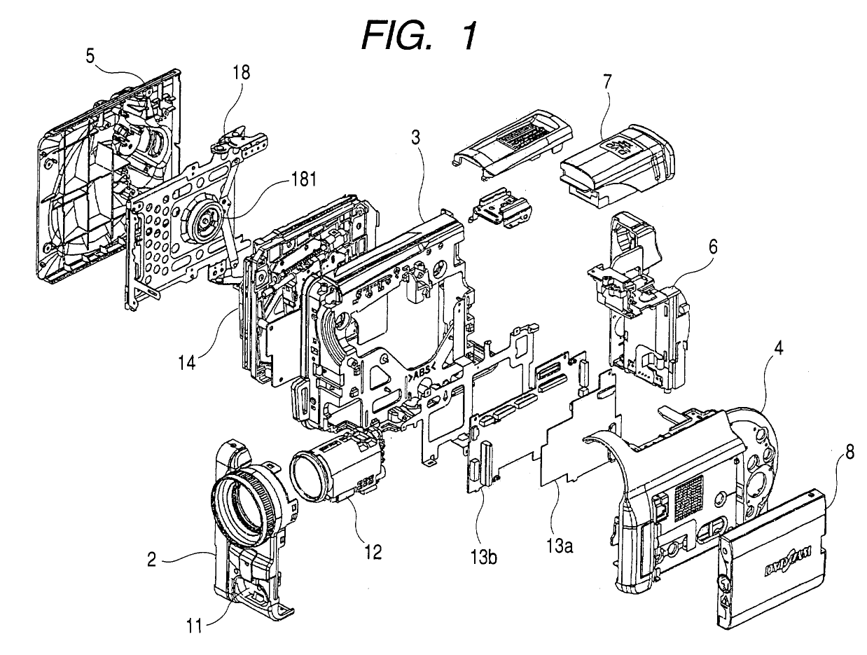

FIG. 1 shows an exploded view of the principle portions of the optical disc video camera, according to an embodiment of the present invention. An outer configure of the optical disc video camera is defined by a front case 2, an R case 3, an L case 4, a disc cover 5, a rear case 6, an EFV portion 7 and an LCD portion, etc. On the front case 2 can be attached a lens portion 12 for picking up video viewed from the EFV portion 7, an accessory shoe for attaching a strobe, etc., thereon, and a microphone for picking up audio. Also, the LCD portion 8 comprises a display portion being able to show or display the video picked up, the video reproduced from a recoding medium loaded, etc. On circuit boards 13A and 13B are formed circuits for controlling the entire operations of the optical disc video camera, such as signal processing of the video picked up through the lens portion 12 and the audio picked up through the microphone 11, and recording the video and the audio finished with the signal processing, etc. In the mechanical portion 14, the video and/or the audio are recorded onto the recording medium, and/or data of the video and the audio recorded is reproduced from the recording medium. Thus, with the present optical disc video camera, data of the video and the audio, etc., are recorded and/or reproduced onto/from the recoding medium, using such as an optical disc utilizing a phase change, through irradiation of lights while rotating the optical disc by the mechanical portion 14.

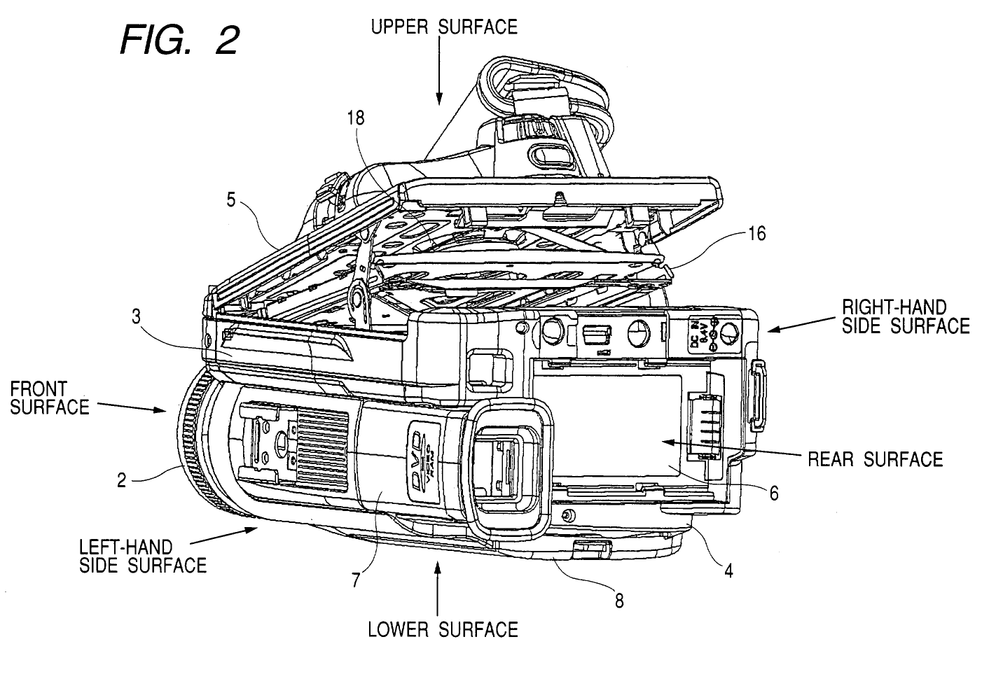

FIG. 2 is a perspective view of the optical disc video camera, seen from behind thereof, under the condition that the disc cover 5 is opened. The cartridge 15, receiving therein the recording medium, i.e., the optical disc is inserted into the cartridge holder 16 of the mechanism portion 14, and further the cartridge is pushed into, thereby the cartridge holder 15 is locked thereon. Further, under the condition that the cartridge 15 is locked on, since a shutter 151 of the cartridge 15 (which will be mentioned later) is opened, therefore the optical disc is exposed. After locking the cartridge 15 on, when a user closes the disc cover 5, then the cartridge 15 is loaded at the position where recording/reproducing of the video and/or audio can be made onto/from the optical disc, therefore the optical disc video camera can record and/or reproduce the video and/or the audio. For loading the recording medium, i.e., the optical disc from the condition shown in FIG. 2 to the position where the recording/reproducing can be made, the user pushes the disc cover 5 (i.e., close) by hand. Further, in the present embodiment, an upper surface, a lower surface, a front surface, a rear surface, and a right-hand and left-hand surfaces mean directions indicated in FIG. 2.

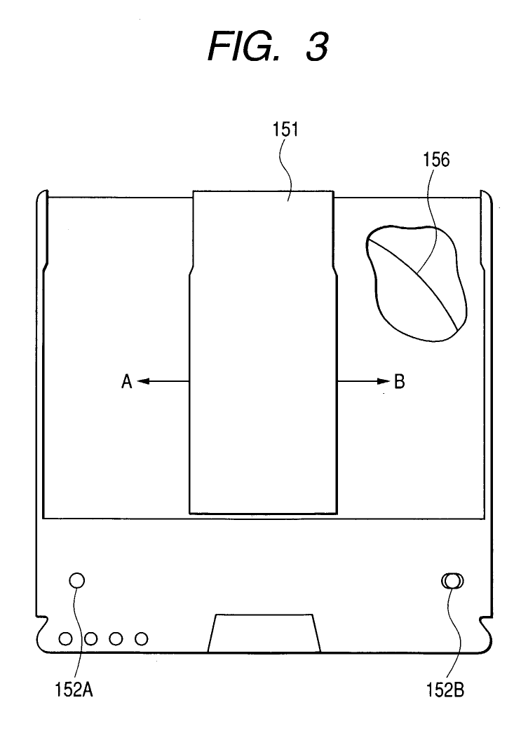

FIG. 3 is a plane view of the cartridge 15 to be used in the optical disc video camera 1. This cartridge 15 receives the recording medium, i.e., an optical disc 156 within an inside thereof, and is constructed so that the optical disc is exposed outside through opening of the shutter 151 thereof. For the optical disc 156 received in the cartridge 15, there are types, such as, a type on both side surfaces of which can be recorded data, such as the video and/or the audio, etc., a type on only one side surface of which can be recorded data, such as the video and/or the audio, etc., and the structure of the cartridge 15 may differ due to this difference. Herein, explanation will be given on the type on both side surfaces of which can be recorded data, such as the video and/or the audio, etc. With the structure of this type, the shutter 151 is opened on both directions, i.e., a direction A and a direction B.

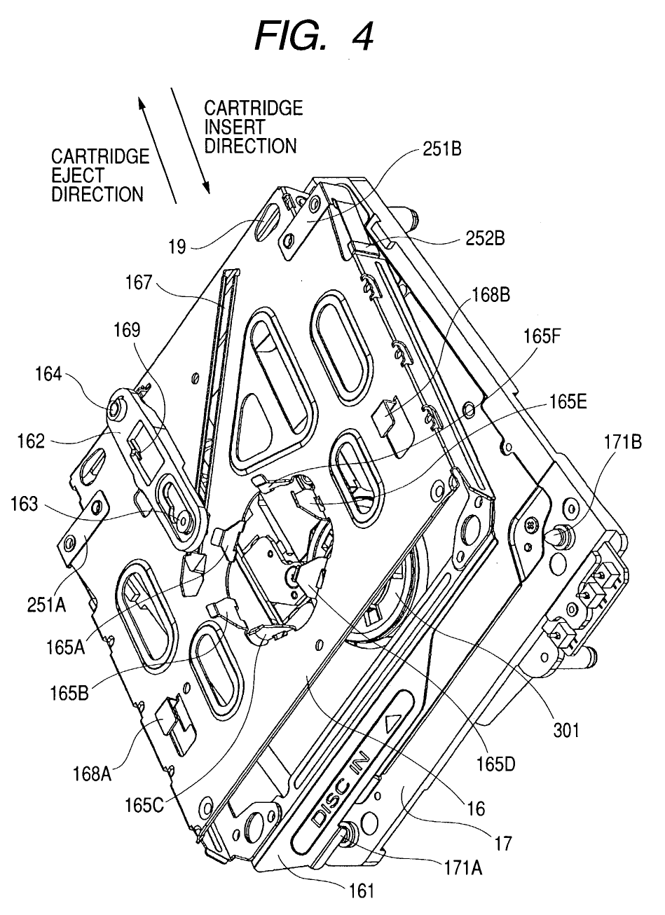

Hereinafter, explanation will be given on a cartridge loading mechanism, which is equipped with the optical disc video camera 1. FIG. 4 shows a perspective view of showing the structure of the mechanism portion 14, seen from the right-hand upper surface side, obliquely. However, in the explanation given hereinafter, the direction of inserting the cartridge, the direction of discharging the cartridge means the directions indicated in this figure.

The mechanism portion 14 comprises, in addition to the cartridge holder 16, a mechanism chassis 17. The mechanism chassis 17 is fixed on the R case 3 of the optical disc video camera 1 through a shock absorption dumper not shown in the figure. On the other hand, the cartridge holder 16 is attached on the mechanism chassis 17 through a bracket attached in a rotatable relationship to the cartridge holder 16. Further, a clump holder 18 for holding a clamper 181 with keeping a gap therebetween is attached to the disc cover 5 of the optical disc video camera. Herein, the disc cover is made of plastic; therefore a reinforcing plate(s) is for necessary for strengthening thereof. Therefore, according to the present embodiment, the clamp holder 18 is made of metal, thereby functioning a reinforcing member of the disc cover 5 made of plastic, in common. In the structure thereof, the cartridge holder 16 and the clamp holder 18 rotate into directions of the upper surface and the lower surface, respectively, accompanying with the open/close operation of the disc cover 5. With such the structure, there is no necessity of a part for exclusive use thereof, such as the disc slider that was used in the conventional art, therefore effects can be obtained on reduction in the number of the parts, as well as, in the thickness of that portion. This FIG. 4 shows the mechanism portion 14 in the condition where the disc cover 5 is opened.

The mechanism chassis 17 has pins 171A and 171B, and those pins 171A and 171B are provided at positions, so that they are inserted into positioning bores 152A and 152B when the cartridge 15 inserted normally. Further, the mechanism chassis 17 comprises a pickup (not shown in the figure) for recording data of the video and/or the audio, etc., by irradiating lights upon the optical disc 156, or reading out data of the video and/or the audio, etc., by receiving reflection light therefrom, a spindle motor 30 for rotating the optical disc 156, and a turn table 301 being provided at a tip of said spindle motor 30 for putting or holding the optical disc 156 therebetween, collaborating with the clamper 181, which will be mentioned later, etc.

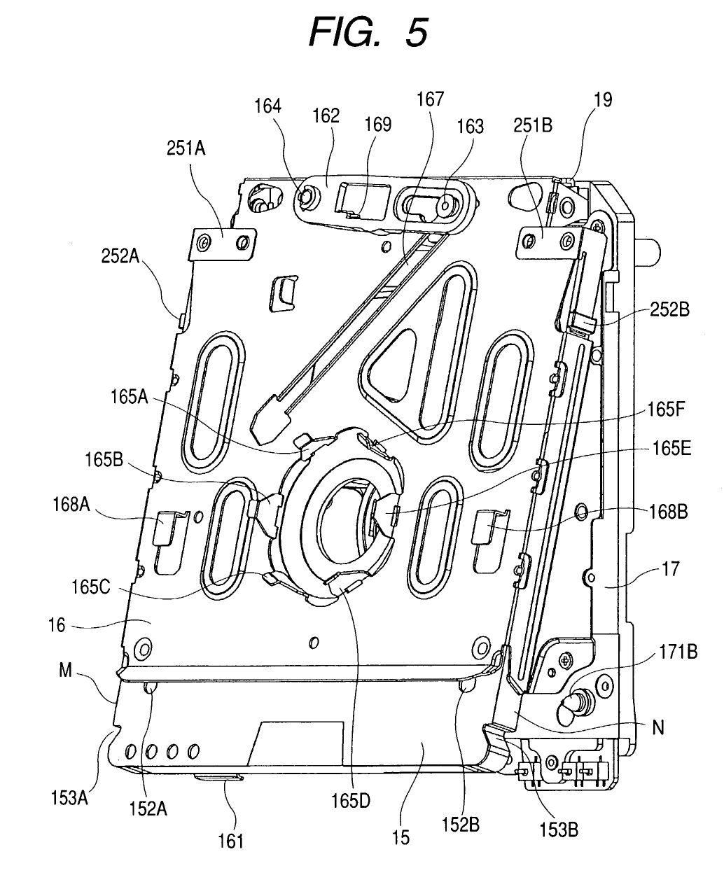

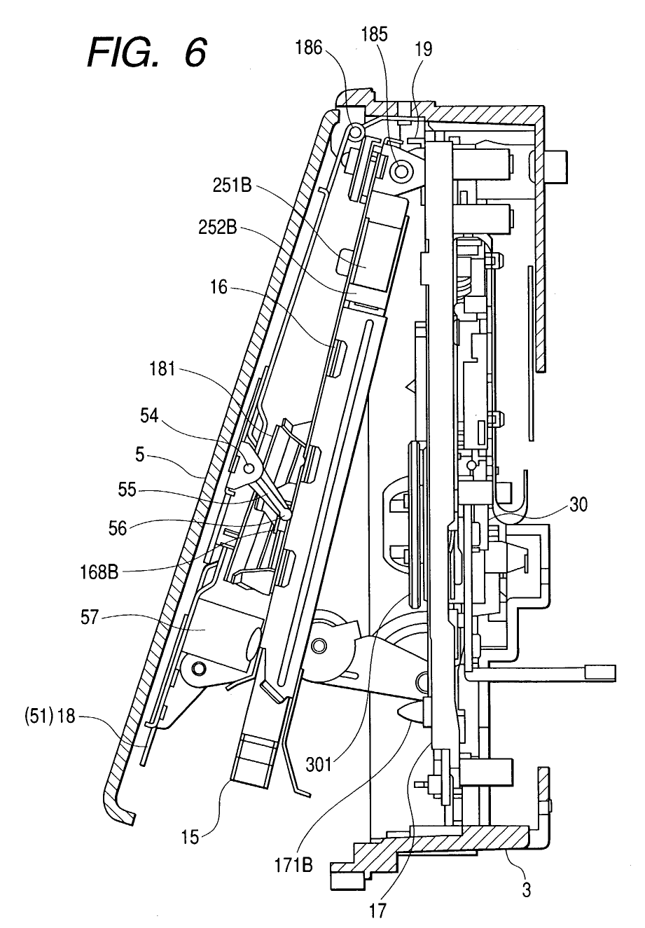

FIG. 5 is a perspective view for showing the condition where the insertion of the cartridge 15 into the cartridge holder 16 is completed by opening the disc cover 5 (wherein the disc cover is not shown in the figure). FIG. 6 is a side view thereof, including a cross-section view of a part thereof. As was mentioned previously, the cartridge holder 16 is attached on the chassis 17 through the bracket 19, while the chassis 17 onto the R case 3. And, the disc cover 5 is also attached onto the R case 3, and the fulcrum of rotational movement of the disc cover 5 is made up with a disc cover rotation shaft 186.

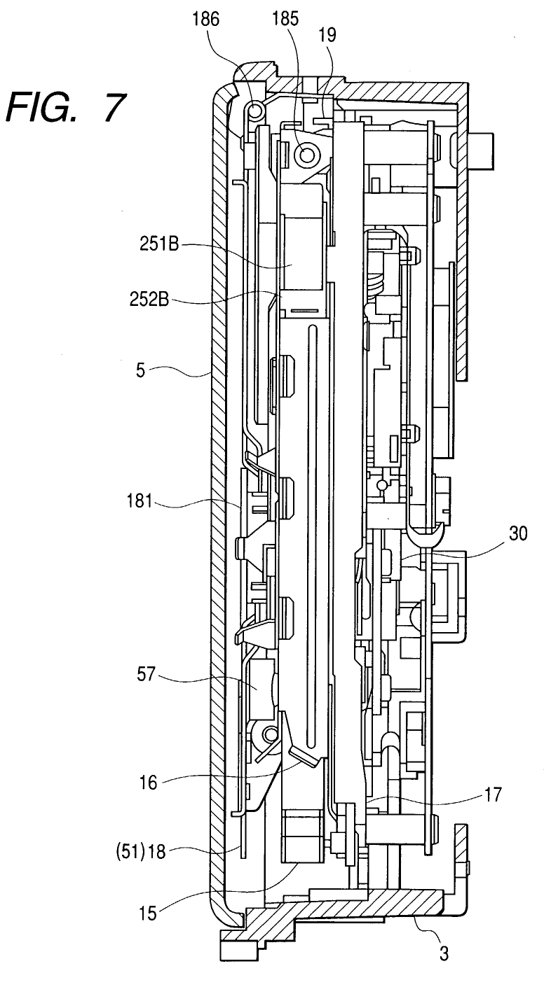

The cartridge holder 16 fixes up the cartridge 16 by means of plate springs 252A and 252B attached to the cartridge holder 16, thereby building up the structure, so that the cartridge 15 cannot be moved, as far as the user thereof tries to withdraw it with an intention to do so, for pulling out the cartridge 15 from the optical disc video camera. Thus, due to the fact that the user of the optical disc video camera closes the disc cover 5 from a stage where this cartridge holder 15 is fixed, the cartridge holder 16 is rotated around a cartridge holder rotation shaft 185, from the position shown in FIG. 6 to the position shown in FIG. 7.

The clamp holder 18 of the disc cover 5 shown in FIG. 6 is bent in a portion thereof, and a link pin J54 is fixed therein. A guide bracket 168B provided on the upper surface of the cartridge holder 16 is engaged with a link pin B 56 provided at one end of a link 55, the other end of which is engaged with the link pin J 54 rotatably.

At the tip side of the clamp holder 18 is fixed a pressurizing plate spring 57, and a free height if the said pressurizing plate spring 57 is larger than the maximum distance between the clamp holder 18 and the cartridge holder 16 determined by the link mechanism mentioned above, For this reason, upon the link pin 54 and the link 55, as well as the guide bracket 168B are always functioned pressures, thereby they are in closely contact with one another.

When the user rotates the disc cover 5 around the disc cover rotation shaft 186, the clamp holder 18 rotates around the disc cover rotation shaft 186, while the cartridge holder 16 around the cartridge holder rotation shaft 185, and the link pin B56 moves sliding on a surface of the guide bracket 168B. Accompanying with rotation of the disc cover 5, there occurs difference in rotation angle between the clamp holder 18 and the cartridge holder 16, therefore the angle defined between the clamp holder 18 and the cartridge holder 16 is large under the condition when the disc cover 5 is opened, while they are almost in parallel under the condition when the disc cover 5 is closed. However, in order to close the disc cover 5, at the final state, it is necessary to give suppression thereon against counter force of the pressurizing plate spring 57. As a result of this, under the condition where the disc cover 5 is opened, as shown in FIG. 6, a whole portions of the clamper 181 held on the clamper holder 18 lies in an outside (an upper side) of the cartridge holder 16, however under the condition where the disc cover 5 is closed, as shown in FIG. 7, a predetermined portion of the clamper 181 enters into the cartridge holder in the condition thereof.

Namely, there is necessity to let the cartridge to escape from, not so as it interfere with the clamper, when inserting the cartridge, however, in the present invention, since the disc cover (an outer cover) is so constructed that the clamper is able to escape into a space defined by opening thereof, therefore there is no necessity of providing the space for escape when the disc cover is closes, thereby bringing about an effect of making thin in the thickness of the apparatus as a whole.

FIG. 7 is a side view of showing the condition where the cartridge 15 is held to be recordable or reproducible in the position thereof. The clamper 181 is mounted with a magnet not shown in the figure in a part thereof. When the optical disc 156 is to be recordable or reproducible in the position thereof, the clamper 181 holds the optical disc 156 between the spindle motor 30, on which an iron member is mounted, due to the magnetic force of the magnet, thereby pressing it onto the turn table 301, so as to be rotated. For this reason, when the optical disc 156 is to be recordable or reproducible in the position, there is no engagement or linkage between the clamper 181 and the clamper holder 18, and also they are attached so as to hold the clamper 181 in a relationship of height thereof, therefore the clamper 181 operates cooperatively with closing/opening of the clamp holder 18, i.e., goes away from the turn table 301.

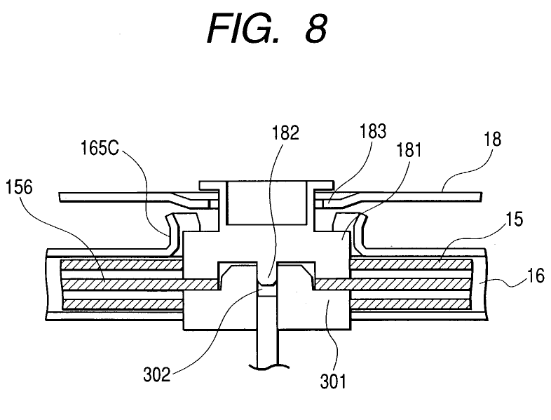

FIG. 8 shows the cross-section view of the principle portion for letting the optical disc 156 to be put or held between the clamper 181 and the turntable 301. The height of the clamper 181 is make small in the diameter thereof, in a part on a way, in the direction of the height, and this portion of the small diameter is engaged with a recess portion 183 of the clamp holder 18, therefore the clamper 181 will never come down therefrom, nor contact with the clamp holder 18 when the optical disc 156 rotates.

When the user of the optical disc camera tries to close the disc cover 5 to make recording or reproducing thereof, after inserting the cartridge 15 therein, a center pin 182 of the clamper 181 rides over a hub center bore 302 on the way of the rotation mentioned above, if the hub center bore 302 at the tip portion 302 of the spindle motor and the center pin 182 of the clamper 181 are not formed within a predetermined accuracy, therefore it is impossible to clamp the disc. In particular, as was mentioned previously, the clamp holder 18, which rotates with the disc cover 5 mounting the clamper 181 thereon as a unit, is attached onto the R case 3, while the cartridge holder 16 onto the chassis 17, and further the chassis 17 is attached onto the R case 3. Therefore, errors in attachment or fitting of the rotation shaft of the clamp holder (i.e., the disc cover rotation shaft) 186 and the rotation shaft 185 of the cartridge holder 16 come to be large, comparing to the conventional art where both of the shafts are same to, due to the large number of parts standing therebetween, thereby increasing a possibility that the center pin 182 may ride over the hub center bore 302.

For this reason, guides 165A to 165F are formed by cutting them up from the cartridge 16, as a unit thereof. And, a gap defined between interior surfaces of the guides 165A to 165F and an outer peripheral surface of the clamper, is made to equal or less than a predetermined value, thereby regulating shifting of the center thereof. The clamper 181 attached onto the clamp holder 18 moves along with the guides 165A to 165F provided in the cartridge holder 16, accompanying with open/close operation of the disc cover 5, and thereby holding the optical disc 156 between the turntable 301 of the spindle motor 30.

In this manner, though the clamper 181 is guided with the guides 165A to 165F provided on the upper surface of the cartridge holder 16, however it is further necessary to suppress a gap defined between an outer diameter of the clamper 181 and inner walls of the guides 165A to 165F. For this, after taking into consideration, the inner diameter of the guides 165A to 165F or a size for regulating a position of the clamper 181, the portions being suppressed as far as possible is provided in a lower half of the guides 165A to 165F. On the other hand, for the purpose of preventing the guides 165A to 165F from being shifted in fore/back directions, caused due to that the clamp holder 18 is higher at the rotation center thereof than the cartridge holder 16 at the rotation center thereof and that there is also a difference in the rotation angles therebetween, when the clamper 18 is opened, and/or from an interference due to the difference in the angle between the clamper 181 and the cartridge holder 16, upper portions of the guides 165A to 165F are opened in an upper direction, and the inner diameter or a size for regulating the position of the clamper 181 is larger than a lower half thereof.

In the process of rotating movement of the cartridge 16 and the clamp holder 18 mentioned above, the pins 171A and 171B on the mechanism chassis 17 shown in FIG. 4 are inserted into the positioning bores 152A and 152B, and thereby the cartridge 15 is position on the mechanism chassis 17. Also, the cartridge 15 is inhibited from being abnormally deformed by means of a guide portion 161 of the cartridge holder 16, when the cartridge 15 is inserted into the cartridge holder 16 in a normal direction, but if the pins 171A and 171B cannot enter into the positioning bores 152A and 152B normally due to shifting of the cartridge caused by some reasons.

Next, explanation will be made on the operation when the cartridge 15 is taken out or ejected, which is loaded inside the optical disc video camera 1. FIG. 6 shows a perspective view of the mechanism portion 14 in the condition that the cartridge 15 loaded inside the optical disc video camera 1 can be taken out therefrom. As is apparent from the fact that the reference numerals attached in the drawings, the present condition is the same to that when the cartridge 15 is completed in the insertion thereof into the cartridge holder 16.

Under the condition of being recordatable or reproducible shown in FIG. 7, when an eject button (mot shown in the figure) thereof, the optical disc video camera release the disc cover from the locking condition thereof. And when the user opens the disc cover 5, the cartridge holder 16 and the clamp holder 18 movers rotationally up to the position shown in FIG. 6. In this instance, both the cartridge holder 16 and the clamp holder 18 are opened relatively while moving rotationally. In the series of operations mentioned above, the cartridge 15 comes in the condition that it can be taken out as shown in FIG. 6, while keeping the condition of the cartridge holder 15 holding the cartridge 16 therewith. The cartridge 15 is kept to be engaged or linked with, by means of the plate-like spring 251A and 251B, each of which shows elasticity in the direction at about perpendicular to that of the ejection of cartridge, as well as, the spring hooks 252A and 252B provided at the tips thereof. Therefore, the user can take out the cartridge 15 from the optical disc video camera 1, by pulling out portions, i.e., M portion and N portion exposed or projected from the cartridge holder of that cartridge 15, in the direction of ejection thereof, so as to release from the linkage with the spring hooks 252A and 252B.

As is fully explained in the above, according to the present invention, in particular in relation to the mechanism for inserting, holding and ejecting the cartridge into the cartridge holder, there can be provided a disc apparatus with a simple structure, therefore being assembled to be small in sizes with ease, while suppressing the necessary parts down to minimal.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A disc apparatus, for recording or reproducing information onto/from a disc medium, by loading a cartridge, in which said disc medium is stored, comprising:
a turntable for rotating said disc medium stored in said cartridge;
a clamper for transmitting a torque from said turn table to said disc medium by pressing said disc medium onto a side of said turntable; and
a cartridge holder for positioning said disc medium within said cartridge at a height so that said disc medium can be rotated by said turntable, when being rotationally closed after said cartridge is inserted into, wherein
said clamper for pressing said disc medium onto the side of said turntable is engaged with a clamp holder, opening/closing with an outer cover as a unit, which makes opening/closing operation when said cartridge is inserted and ejected.

2. A disc apparatus as described in the claim 1, wherein said outer cover is made of plastic material, while said clamp holder of metal mainly, and said clamp holder has a function of a reinforce plate of said outer cover in common.

3. A disc apparatus as described in the claim 1, wherein
said clamp holder and said cartridge holder make up a link mechanism; and
an angle defined between said clamp holder and said cartridge holder is large in a condition where said outer cover is opened, while said clamp holder and said cartridge holder are about in parallel with each other in a condition where said outer cover is closed, accompanying with the opening/closing operation of said outer cover.

4. A disc apparatus for recording or reproducing information onto/from a disc medium, by loading a cartridge, in which said disc medium is stored, comprising:
an outer cover making opening/closing operation when said cartridge is inserted and ejected;
a turntable for rotating said disc medium stored in said cartridge;
a clamper, being movable in collaboration with the opening/closing of said outer cover, for transmitting a torque from said turntable to said disc medium, by pressing said disc medium onto said turntable; and
a cartridge holder for positioning said disc medium within said cartridge at a height so that said disc medium can be rotated by said turntable, when being rotationally closed after said cartridge is inserted into, wherein
said cartridge holder comprises a guide portion for regulating movement of said clamper, and said guide portion is formed on said cartridge holder as a unit.

5. A disc apparatus, as described in the claim 4, wherein said clamper for pressing said disc medium onto the side of said turntable is engaged with a clamp holder, opening/closing with an outer cover as a unit, which makes opening/closing operation when said cartridge is inserted and ejected.

6. A disc apparatus, as described in the claim 4, wherein said guide portion formed on said cartridge holder is so shaped that a gap defined between said clamper and said guide portion comes to be small gradually when said clamper moves towards said turntable.

7. A disc apparatus, as described in the claim 4, wherein
said guide portion formed on said cartridge holder is made from cut up pieces, each of which is cut up from said cartridge holder as a unit; and
said cut up pieces are opened radially upward at tip portions thereof, while an inner diameter thereof or a size of regulating a position of said clamper is larger than that of the cut up portions.
